(19) United States
(12) Patent Application Publication
(10) Pub. No.: US 2015/0302277 A1
(43) Pub. Date: Oct. 22, 2015

(54) IMAGE PROCESSING APPARATUS, IMAGE PROCESSING SYSTEM, AND IMAGE PROCESSING METHOD

(71) Applicant: Kohei SUZUKI, Tokyo (JP)

(72) Inventor: Kohei SUZUKI, Tokyo (JP)

(73) Assignee: RICOH COMPANY, LTD., Tokyo (JP)

(21) Appl. No.: 14/689,218

(22) Filed: Apr. 17, 2015

(30) Foreign Application Priority Data
Apr. 21, 2014 (JP) 2014-087130
Apr. 7, 2015 (JP) 2015-078125

(51) Int. Cl. G06K 9/72; G06K 9/00

(52) U.S. Cl. CPC G06K 9/72; G06K 9/00442

(57) ABSTRACT

An image processing apparatus includes a receiving unit configured to present an image that is a processing target to a user and receive a specification of an area in the image; a character recognition unit configured to perform a character recognition process on the area for which the receiving unit has received the specification in the image that is the processing target, and acquire an information item of a character string in the area; and a setting unit configured to set management information of the image that is the processing target, based on the character string acquired by the character recognition unit.

### BACKGROUND OF THE INVENTION

1. Field of the Invention

The present invention relates to an image processing apparatus, an image processing system, and an image processing method.

2. Description of the Related Art

Conventionally, image data has been managed with the use of a file name, a directory name, or other metadata. Information, which is preferably used for such management, is often included in an image, as a document title, an issue date, and a management number (when the image data that is the management target is obtained by reading an image of an original document, the information is described in the paper document).

Patent Document 1 discloses a technology of performing an OCR (Optical Character Recognition) process on image data to obtain characters, and displaying the obtained characters as shaded text in an image, such that the user is able to select characters to be used as a document name from among the displayed characters. By using this technology, it is possible to easily set characters included in an image as a document name. However, by the technology described in

Patent Document 1, it is necessary to perform an OCR process on the entire image data that is the processing target, and therefore there has been a problem in that a long processing time and many calculation resources of the device are necessary.

Furthermore, the OCR process is performed with respect to a larger area than the area that actually includes the necessary character information, and therefore the processing time and consumed calculation resources are mostly wasted. This tendency is particularly significant in the case of processing an image like an architectural drawing, which includes a very small amount of bibliographic information (title of drawing, management number, etc.) with respect to a gigantic diagram from which no character strings are recognized. There may be cases where an OCR process is performed with respect to an area that is several hundred times as large as the area that actually includes the necessary character information.

Furthermore, as another method, the character string that is the candidate management data may be extracted from the image data, according to a predetermined format such as coordinate information set in advance. This method is preferable for a process on image data that is obtained by reading an original document of a fixed format such as a slip; however, this method is problematic in purposes of processing images of unfixed formats as needed.

Patent Document 1: Japanese Laid-Open Patent Publication No. 2005-275849

### SUMMARY OF THE INVENTION

The present invention provides an image processing apparatus, an image processing system, and an image processing method, in which one or more of the above-described disadvantages are eliminated.

According to an aspect of the present invention, there is provided an image processing apparatus including a receiving unit configured to present an image that is a processing target to a user and receive a specification of an area in the image; a character recognition unit configured to perform a character recognition process on the area for which the receiving unit has received the specification in the image that is the processing target, and acquire an information item of a character string in the area; and a setting unit configured to set management information of the image that is the processing target, based on the character string acquired by the character recognition unit.

According to an aspect of the present invention, there is provided an image processing system including a receiving unit configured to present an image that is a processing target to a user and receive a specification of an area in the image; a character recognition unit configured to perform a character recognition process on the area for which the receiving unit has received the specification in the image that is the processing target, and acquire an information item of a character string in the area; and a setting unit configured to set management information of the image that is the processing target, based on the character string acquired by the character recognition unit.

According to an aspect of the present invention, there is provided an image processing method including presenting an image that is a processing target to a user and receiving a specification of an area in the image; performing a character recognition process on the area for which the specification has been received in the image that is the processing target, and acquiring an information item of a character string in the area; and setting management information of the image that is the processing target, based on the acquired character string.

### BRIEF DESCRIPTION OF THE DRAWINGS

Other objects, features and advantages of the present invention will become more apparent from the following detailed description when read in conjunction with the accompanying drawings, in which:

FIG. 1 illustrates a hardware configuration of an image reading device that is an example of an image processing apparatus according to an embodiment of the present invention;

FIG. 2 illustrates a configuration of functions of the image reading device illustrated in FIG. 1;

FIG. 3 illustrates an example of an area specification receiving screen;

FIG. 4 is a sequence diagram of an example of operations performed by the units of the image reading device illustrated in FIG. 1 and by a user;

FIG. 5 is a sequence diagram of operations continued from FIG. 4;

FIGS. 6A through 6C illustrate examples of screen displays according to the operations of FIGS. 4 and 5;

FIG. 7 illustrates an example of specification of a plurality of areas;

FIG. 8 is a diagram for describing the purpose of performing character recognition on an area that is different from the area specified by the user;

FIG. 9 illustrates an example of a character string selection screen; and

FIG. 10 is another diagram for describing the purpose of performing character recognition on an area that is different from the area specified by the user.

### DETAILED DESCRIPTION OF THE PREFERRED EMBODIMENTS

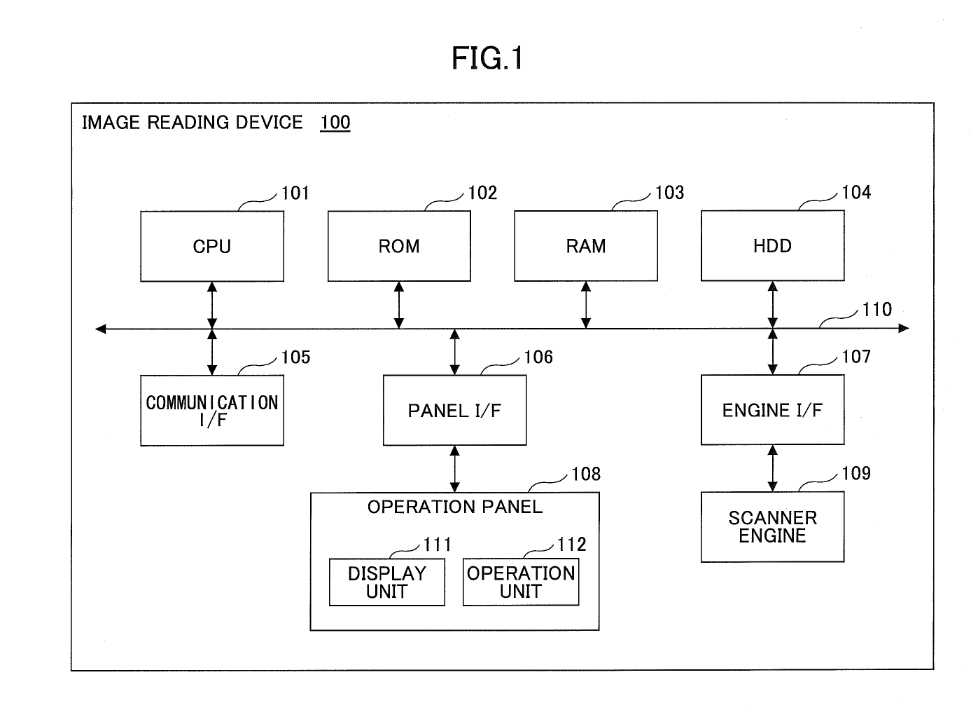

FIG. 1 illustrates a hardware configuration of an image reading device that is an example of an image processing apparatus according to an embodiment of the present invention.

As illustrated in FIG. 1, an image reading device 100 includes a CPU 101, a ROM 102, a RAM 103, a HDD (Hard Disk Drive) 104, a communication I/F (interface) 105, a panel I/F 106, and an engine I/F 107, which are interconnected by a system bus 110. Furthermore, to the panel I/F 106, an operation panel 108 is connected, and to the engine I/F 107, a scanner engine 109 is connected.

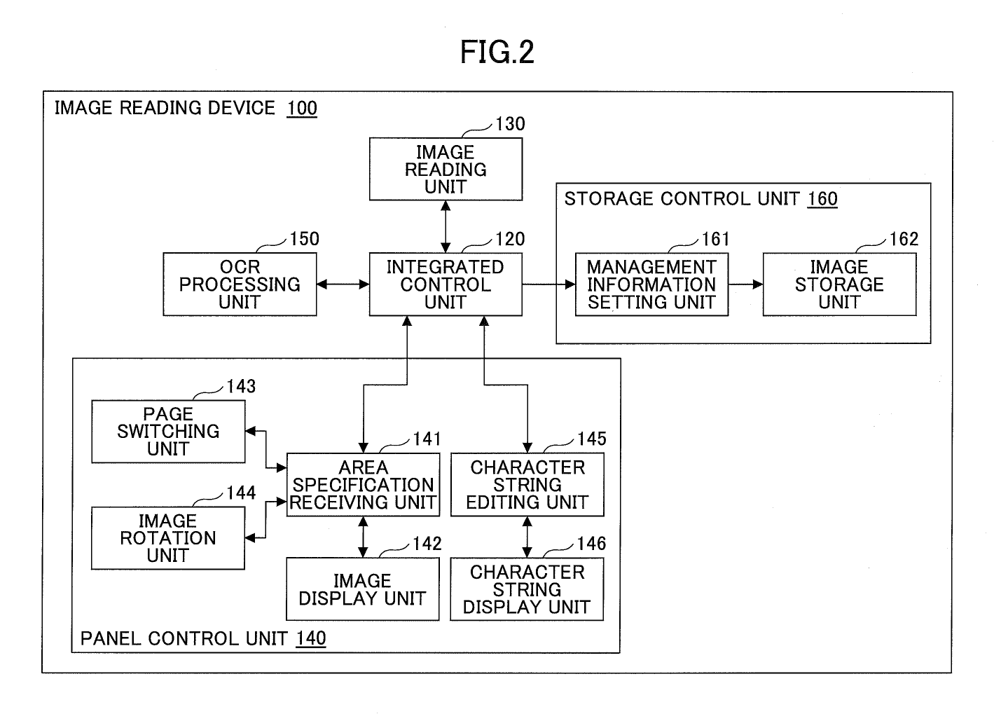

The CPU 101 executes a program stored in the ROM 102 or the HDD 104 by using the RAM 103 as a work area, to control the entire image reading device 100 and realize various functions such as those described below with reference to FIG. 2. For example, there are functions such as reading an image of an original document; presenting the image, which has been obtained by the reading process, to a user, and receiving a specification of an area in the image; performing a character recognition process on the specified area; and setting management information of the image based on a character string acquired by the character recognition process.

The ROM 102 and the HDD 104 are non-volatile storage media (storage units), and store various programs executed by the CPU 101 and various kinds of data described below.

The communication I/F 105 is an interface for communicating with an external device via a network (not illustrated).

The panel I/F 106 is an interface for connecting the operation panel 108 to the system bus 110, such that the operation panel 108 can be controlled from the CPU 101. Furthermore, the operation panel 108 includes a display unit 111 and an operation unit 112.

The display unit 111 is a presenting unit for presenting to the user the operation state, the setting content, etc., of the image reading device 100, and the display unit 111 includes a liquid-crystal display, a lamp, etc. Furthermore, the display unit 111 can display an image obtained by a reading process by the scanner engine 109, for receiving, from the user, a specification of an area in the displayed image.

The operation unit 112 is an operation unit for receiving operations by the user. The operation unit 112 includes various buttons, switches, and a touch panel, and the operation unit 112 can receive operations (specification of an area, an operation with respect to the GUI (Graphical User Interface), etc.) made with respect to an image displayed by the display unit 111.

Note that when there is no need for the image reading device 100 to directly receive an operation from the user (when an operation can be received by an external device connected via the communication I/F 105), the operation panel 108 does not need to be provided.

The engine I/F 107 is an interface for connecting the scanner engine 109 to the system bus 110, such that the scanner engine 109 can be controlled from the CPU 101. Furthermore, the scanner engine 109 is an image reading unit provided with a function of reading an image of an original document placed on a predetermined mounting table, and outputting image data indicating the contents of the image. The scanner engine 109 may have a publicly known configuration.

Next, FIG. 2 illustrates a configuration of functions relevant to reading an image and setting management information with respect to the image, provided in the image reading device 100. The functions illustrated in FIG. 2 are realized as the CPU 101 controls various hardware elements illustrated in FIG. 1 by executing required programs.

As illustrated in FIG. 2, the image reading device 100 includes an integrated control unit 120, an image reading unit 130, a panel control unit 140, an OCR processing unit 150, and a storage control unit 160.

Among these, the integrated control unit 120 is for managing the operations of all of the functions illustrated in FIG. 2, and includes functions of instructing other units to execute an operation, passing necessary information to the respective units, and acquiring information indicating operation results from the respective units.

The image reading unit 130 has a function of an image reading unit for controlling the scanner engine 109 to read an image of an original document according to an instruction from the integrated control unit 120, and acquiring the image data. Furthermore, the image reading unit 130 passes the acquired image data to the integrated control unit 120.

The panel control unit 140 has a function of controlling the operation panel 108. Furthermore, the panel control unit 140 is a receiving unit having a function of displaying, by the operation panel 108, an image based on image data acquired by the image reading unit 130, and a function of a receiving unit for receiving, from the user, a specification of an area in the image indicated by the image data.

More specifically, the panel control unit 140 includes an area specification receiving unit 141, an image display unit 142, a page switching unit 143, an image rotation unit 144, a character string editing unit 145, and a character string display unit 146.

Among these, the area specification receiving unit 141 has a function of acquiring, from the integrated control unit 120, the image data obtained by the image reading unit 130 by a scanning process; and receiving, from a user by a touch panel included in the operation unit 112, a specification of an area in the image indicated by the image data. The received specification of an area is returned to the integrated control unit 120. At this time, when the page has been switched and the image has been rotated as described below, information indicating these changes is also returned to the integrated control unit 120.

Furthermore, the area specification receiving unit 141 has a function of processing the received data according to need, passing the processed image data to the image display unit 142, and displaying, on a display of the display unit 111, an area specification receiving screen including an image based on the image data. In the present embodiment, as described below, the specification of an area is received as an operation made with respect to the area specification receiving screen that is a GUI displayed on the display.

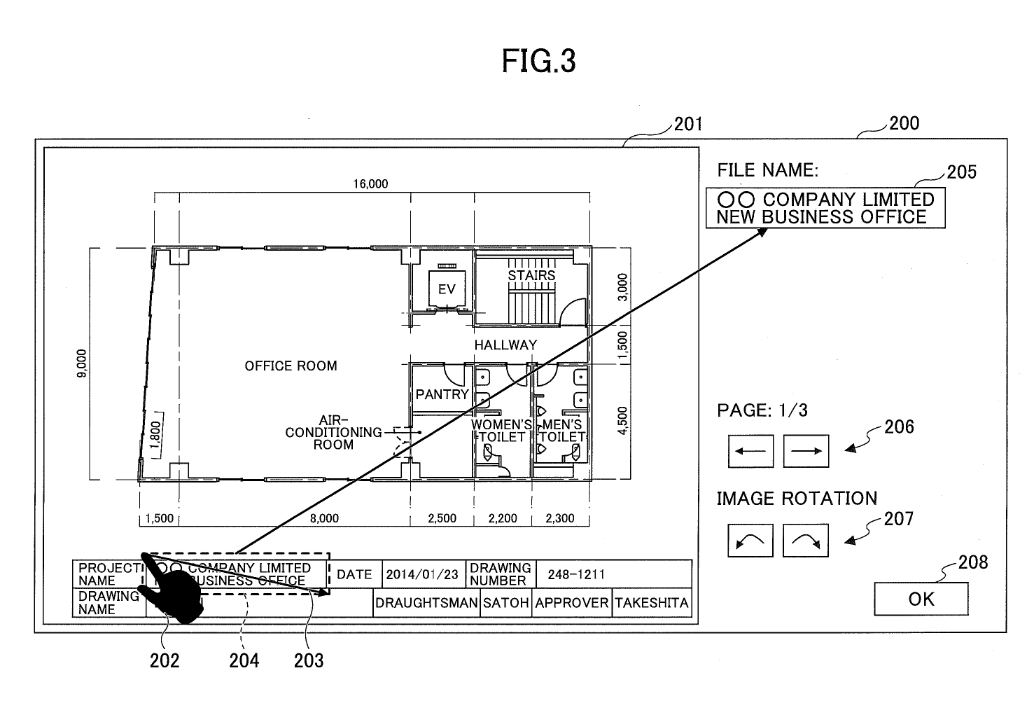

The image display unit 142 has a function of controlling the display of the display unit 111 according to an instruction from the area specification receiving unit 141, and displaying an area specification receiving screen including an image indicated by the received image data. Details of the area specification receiving screen are described below with reference to FIG. 3.

The page switching unit 143 has a function of receiving an instruction to switch the page of the image in the area specification receiving screen, and switching the page of the image to be passed to the image display unit 142 from the area specification receiving unit 141, according to the received instruction. When a plurality of pages of original documents are continuously read, the image data output by the image reading unit 130 may include images of a plurality of pages. The page switching unit 143 switches the page in the image, for which a specification of an area is to be received by the area specification receiving unit 141. Thus, the image displayed on the image display unit 142 is obviously an image of the page for which a specification of an area is to be received.

The image rotation unit 144 is a rotation unit having a function of receiving an instruction to rotate an image in the area specification receiving screen, and rotating the orientation of an image indicated by the image data to be passed to the image display unit 142 from the area specification receiving unit 141, according to the received instruction. When an original document is placed on the scanner engine 109 in an oblique manner, the image data obtained as the reading result will indicate an oblique image, and the area may be difficult to specify by displaying the oblique image without modification. The image rotation unit 144 is provided for resolving such a situation, by rotating the image to be displayed in the screen, such that the image is displayed in a state where the user can easily specify the area (for example, a horizontal state).

The character string editing unit 145 has a function of acquiring, from the integrated control unit 120, a character string obtained by an OCR process performed by the OCR processing unit 150; receiving, by the operation unit 112, an editing operation made with respect to the acquired character string; and editing the character string according to the operation. Furthermore, the character string that has undergone the editing, is returned to the integrated control unit 120. Note that the editing performed by the character string editing unit 145 includes, for example, directly editing characters by a keyboard or an on-screen keyboard (input or delete), adding and inserting a character string indicating the present time and date, adding and inserting a character string indicating the time and date of reading the original document, adding and inserting a fixed character string registered in advance, adding and inserting a fixed character string that is frequently used in file management, undoing and redoing the editing that has already been performed, etc. Information of the time and date, the fixed phrase, etc., may be acquired by sending a request to the integrated control unit 120.

Furthermore, the character string editing unit 145 has a function of passing the received character string to the character string display unit 146, and displaying the character string as a candidate of the file name of the image data in the area specification receiving screen of FIG. 3. When the character string has been edited, the character string to be passed to the character string display unit 146 is also changed accordingly.

The character string display unit 146 has a function of controlling the display of the display unit 111 according to an instruction from the character string editing unit 145, and displaying the received character string in the area specification receiving screen.

Next, the OCR processing unit 150 has a function of performing a character recognition method of performing an OCR process on the area specified by the integrated control unit 120 in the image data passed from the integrated control unit 120, as a character recognition for acquiring information of a character string in the specified area, and outputting the acquired information of the character string as text data, according to an instruction from the integrated control unit 120. The output data is passed to the integrated control unit 120. Furthermore, as the algorithm itself of the OCR process in the area, a publicly known algorithm may be used according to need.

Note that among the image data acquired from the image reading unit 130, the integrated control unit 120 passes the image data of the page including the area for which a specification has been received by the area specification receiving unit 141, to the OCR processing unit 150 together with coordinate data of the area. Furthermore, when the image has been rotated at the time point of receiving the specification of the area, the integrated control unit 120 passes, to the OCR processing unit 150, image data in which the image has been rotated by the same extent, as the target of the OCR process.

Next, the storage control unit 160 has a function of setting management information with respect to the image data passed from the integrated control unit 120 based on the character string passed from the integrated control unit 120, and storing the image data, according to an instruction from the integrated control unit 120. A management information setting unit 161 is a setting unit having the function of setting the management information, and an image storage unit 162 has the function of storing the image data.

Here, the management information is, for example, the file name when storing the image data as a file. In this case, the management information setting unit 161 may attach an appropriate extension to the character string passed from the integrated control unit 120. The management information may be other arbitrary data used for managing the image data in association with the image data, such as a name of the directory in which the image data is to be stored, a value of an item in the property of the image data, a value of an appropriate item associated with the image data when storing the image data in a database, etc.

Furthermore, the storage destination of storing the image data by the image storage unit 162 may be an arbitrary external storage, other than the HDD 104, such as a storage provided in a cloud environment.

Note that the integrated control unit 120 passes, to the management information setting unit 161, the image data acquired from the image reading unit 130, together with a character string which has been output by the OCR processing unit 150 and which has been subsequently edited by the character string editing unit 145 according to need. Furthermore, when the image has been rotated at the time point of receiving the specification of the area by the area specification receiving unit 141, the integrated control unit 120 passes, to the management information setting unit 161, image data in which the image in each page has been rotated by the same extent, as the target of storage instead of the image data acquired from the image reading unit 130. Alternatively, only the image in the page for which an area has been specified may be rotated.

Next, FIG. 3 illustrates an example of the area specification receiving screen described above.

As illustrated in FIG. 3, an area specification receiving screen 200 includes an image display area 201, a file name candidate display part 205, a page switching button 206, an image rotation button 207, and an OK button 208.

Among these, the image display area 201 is a part where an image to be the target of receiving a specification of an area is displayed, by the function of the image display unit 142. For example, when the area specification receiving screen 200 is displayed on a display in which a touch panel is superposed, the user can swipe (trace) the screen with his finger 202 to specify a rectangular area 204 having the traced line 203 as the diagonal line. Otherwise, the user can specify an area by a dragging operation using a pointing device such as a mouse, an operation of surrounding the area with four sides, or other operations. Furthermore, the specification of the area can be completed as the swipe operation is completed, or a button may be operated to indicate the completion of the specification of an area.

Furthermore, the image can be scrolled, enlarged, or reduced, by swiping, flicking, pinch-in, pinch-out, etc.

Furthermore, the file name candidate display part 205 is a part for displaying a candidate of a character string used for setting management information (here, a file name) of image data, by a function of the character string display unit 146. The file name candidate display part 205 is blank at first. Then, when the user specifies an area in the image in the image display area 201, the integrated control unit 120 causes the OCR processing unit 150 to perform an OCR process on the image of the area, and causes the file name candidate display part 205 to display the resultant character string by the function of the character string display unit 146. In FIG. 3, the arrow extending from the area 204 indicates this operation.

The page switching button 206 is a button for instructing to switch the page of the image to be displayed in the image display area 201. When there is a page switching instruction, the page switching unit 143 switches the page, and the display in the image display area 201 is updated accordingly.

The image rotation button 207 is a button for instructing to rotate the image to be displayed in the image display area 201. When there is a rotation instruction, the image rotation unit 144 rotates the displayed image, and the display in the image display area 201 is updated accordingly.

The OK button 208 is a button for determining to use a character string displayed in the file name candidate display part 205 as a setting of the file name, and instructing to shift to the process of storing the file. Before operating the OK button 208, the user is able to edit the character string displayed in the file name candidate display part 205 as described with respect to the character string editing unit 145, by using a key, a button, a GUI (not illustrated), etc.

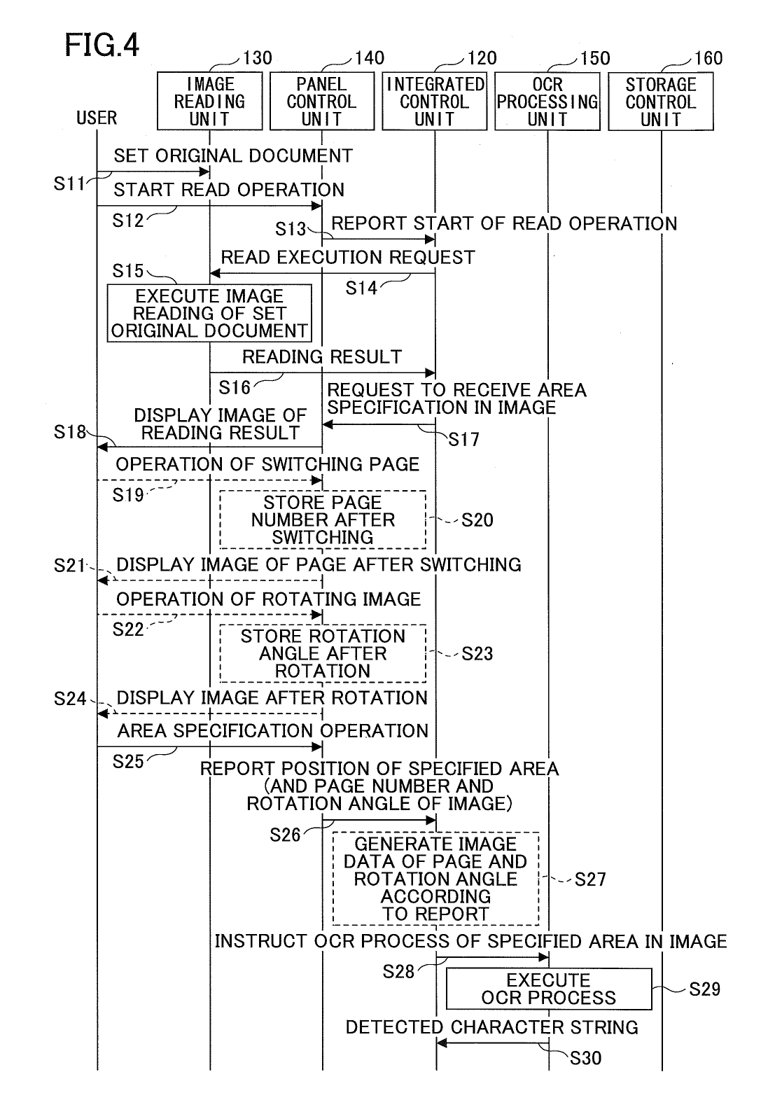

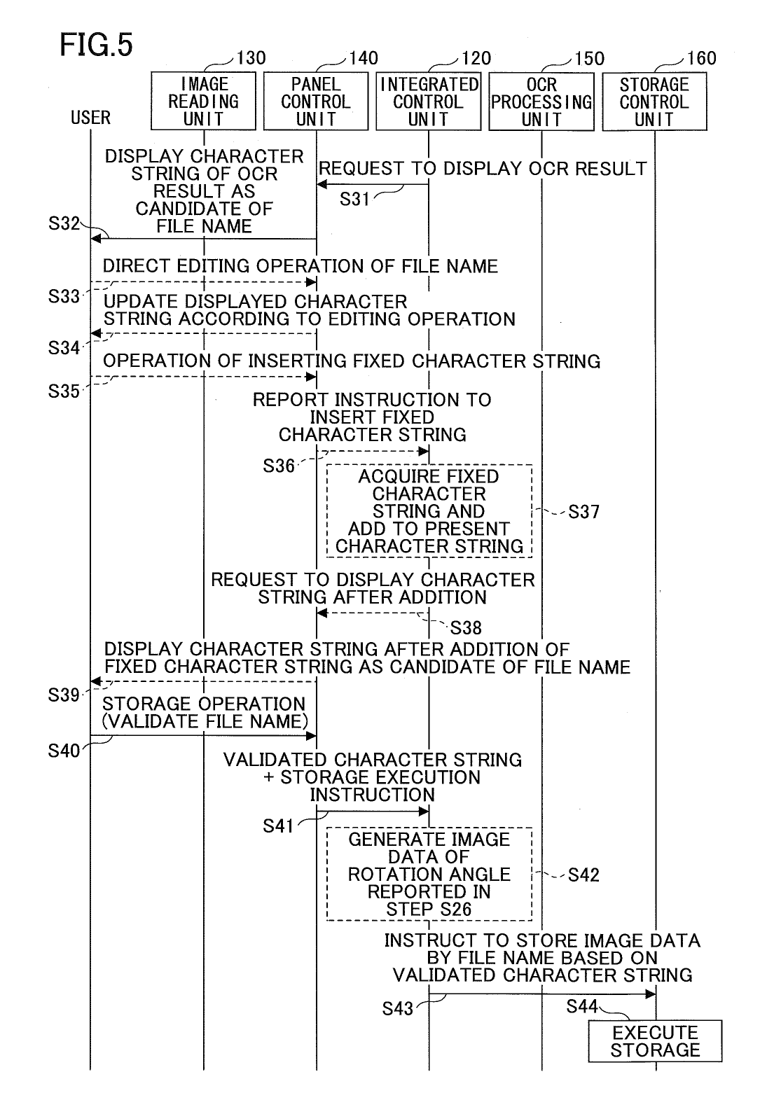

Next, FIGS. 4 and 5 illustrate an operation sequence performed by the units illustrated in FIG. 2, in a case where the image reading device 100 stores an image that has been read by attaching a file name generated from a character string included in the image. Note that the operation sequence of FIGS. 4 and 5 includes operations performed by the user.

The operation of FIG. 4 is started as the user sets an original document to be read, on a document mounting table of the scanner engine 109 controlled by the image reading unit 130 (step S11). In the following description, it is assumed that the operations of the image reading unit 130 include operations of the scanner engine 109.

Next, the user performs an operation of instructing to start reading the image, with respect to the operation unit 112 of the operation panel 108 controlled by the panel control unit 140 (step S12). When the panel control unit 140 detects this operation, the panel control unit 140 reports this to the integrated control unit 120 (step S13).

In response to the report of step S13, the integrated control unit 120 requests the image reading unit 130 to execute reading (step S14). In response to this request, the image reading unit 130 reads the image of the original document set on the document mounting table (step S15), and returns the image data of the original document as a reading result to the integrated control unit 120 (step S16). In the following, unless particularly mentioned, this image data is the image data that is the processing target. Note that in step S15, the image reading unit 130 may sequentially read a plurality of pages of original documents. In this case, the image data obtained as the reading result becomes data including images of a plurality of pages.

When the integrated control unit 120 acquires the image data that is the reading result, the integrated control unit 120 passes the image data to the panel control unit 140, and requests to receive a specification of an area in the image (image that is the processing target) indicated by the image data (step S17).

The panel control unit 140 presents the image to the user in response to this request, by causing the display unit 111 of the operation panel 108 to display the image obtained as the reading result, based on the received data (step S18). When there are images of a plurality of pages, the image of the first page is to be displayed. Here, the image is assumed to be displayed in the image display area 201 of the area specification receiving screen 200 illustrated in FIG. 3.

Subsequently, the panel control unit 140 receives various operations from the user with respect to the area specification receiving screen 200, and performs operations according to the received operations.

First, when there is an operation to switch the page (an operation of the page switching button 206) (step S19), the panel control unit 140 switches the page to be displayed according to the operation, and stores the page number after the switching (step S20). Then, the panel control unit 140 causes the display unit 111 to display the image after the page has been switched (step S21).

Furthermore, when there is an operation to rotate the image (an operation of the image rotation button 207) (step S22), the panel control unit 140 rotates the image being displayed according to the operation, and stores the rotation angle after the rotation (step S23). Then, the panel control unit 140 causes the display unit 111 to display the image after being rotated (step S24). Note that the operation of switching the page and the operation of rotating the image may be executed for an arbitrary number of times including zero, and in an arbitrary order.

Subsequently, the user finds, in the displayed image, an area including a character string to be used for managing the image data, such as a document name, a date/month/year of issue, a serial number, etc., and performs an area specification operation of specifying the found area (here, a swipe operation on the image display area 201).

Then, when the area specification operation is made (step S25), the panel control unit 140 acquires position information of the specified area, based on the range of the swipe operation. Then, the panel control unit 140 reports the position of the specified area to the integrated control unit 120 (step S26). At this time, when the page has been switched or the image has been rotated, the page number of the page including the specified area and the rotation angle of the image are also reported.

When the integrated control unit 120 receives this report, the integrated control unit 120 extracts the image of the reported page number from the image data obtained as the reading result, and generates image data of an image that has been rotated by the reported rotation angle, according to need (when the image has been rotated) (step S27). Then, the integrated control unit 120 passes, to the OCR processing unit 150, the generated image data or image data of the page including the specified area among the image data obtained as the reading result (when the image is not rotated), together with the position information of the specified area, and instructs the OCR processing unit 150 to perform an OCR process on the area relevant to the position information among the passed image data (step S28). Alternatively, the integrated control unit 120 may cut out the image data of the area to undergo an OCR process from the entire image data, and pass the cutout image data to the OCR processing unit 150.

The OCR processing unit 150 executes an OCR process according to the instruction of step S28 (step S29), and returns, to the integrated control unit 120, the character string detected by the OCR process, i.e., the information of the character string included in the specified area in the image (step S30).

Next, the operation proceeds to the part illustrated in FIG. 5, and the integrated control unit 120 passes the character string acquired as a result of step S30 to the panel control unit 140, and requests the panel control unit 140 to display the character string (step S31).

In response to this request, the panel control unit 140 causes the display unit 111 to display the received character string (step S32). Here, the character string is displayed as a candidate of a file name to be attached to the image data, in the file name candidate display part 205 in the area specification receiving screen 200.

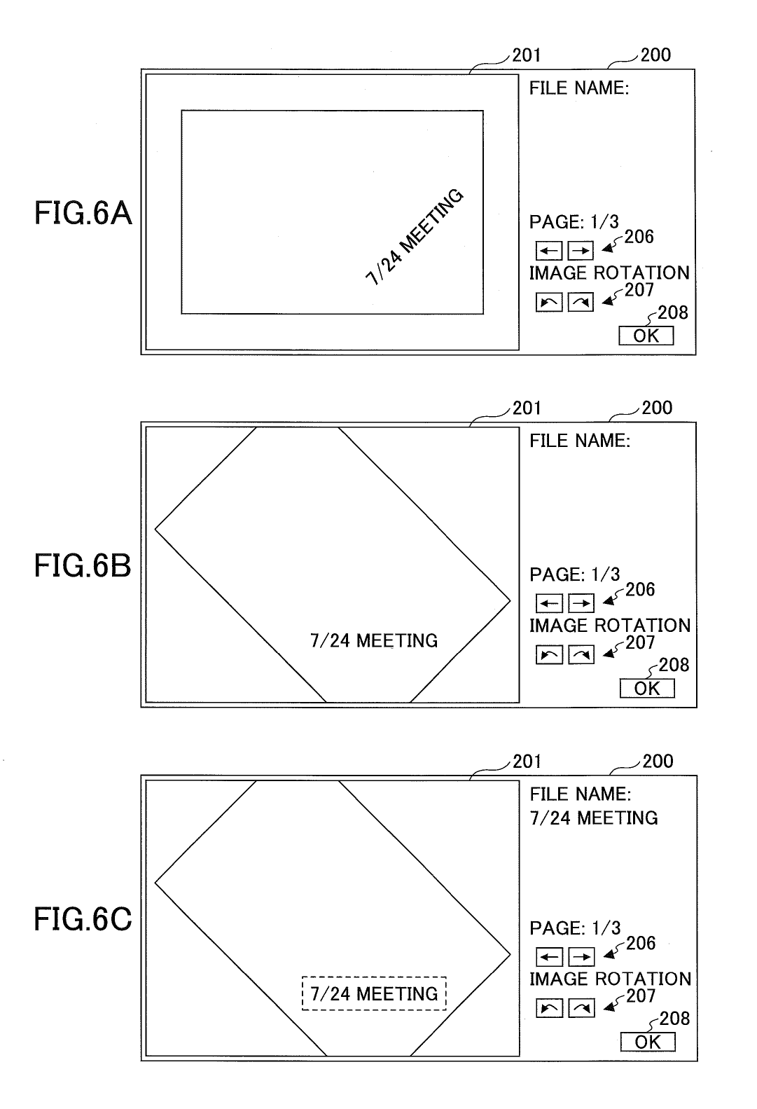

Here, a description is given of examples of screen displays of the processes of steps S22 through S32, with reference to FIGS. 6A through 6C. When the page is switched in step S21, for example, the screen of FIG. 6A is displayed. In this screen, when the operation of rotating the image of step S22 is received (the image rotation button 207 is operated, a rotation operation is performed in the image display area 201, etc.), the panel control unit 140 changes the display of the image display area 201 to that as illustrated in FIG. 6B. Then, when the area specification operation of step S25 is received, the panel control unit 140 displays a frame indicating the specified area as illustrated in FIG. 6C, and displays the candidate of the file name as illustrated in FIG. 6C according to the processes of steps S26 through S32.

Subsequently, the panel control unit 140 receives various operations from the user with respect to the area specification receiving screen 200 or other operation pieces, and performs operations according to the operations received from the user.

First, when there is an operation of directly editing the file name (character string) (step S33), the panel control unit 140 updates the displayed character string according to the editing operation (step S34).

Furthermore, when there is an operation to insert a fixed character string (step S35), the panel control unit 140 reports to the integrated control unit 120 that there has been an instruction to insert a fixed character string (step S36). The integrated control unit 120 acquires the fixed character string in response to this report (step S37), and requests the panel control unit 140 to display the character string by adding the fixed character string to the present character string (step S38). In response to this request, the panel control unit 140 causes the file name candidate display part 205 to display the character string after adding the fixed character string, as a candidate of the file name (step S39). Note that the fixed character string in this example may include a character string that is dynamically generated, such as the above-described time and date of reading the original document, other than a fixed character string.

Note that the operation of directly editing the character string and the operation of inserting a fixed character string may be executed for an arbitrary number of times including zero, and in an arbitrary order. Furthermore, the panel control unit 140 may similarly execute a processing process on the character string according to an editing operation other than that specifically described herein. Furthermore, when the user performs an area specification operation again, the process can be redone by returning to step S25 of FIG. 4.

Subsequently, when there is an operation of validating the displayed character string as a file name and storing the character string (operation on the OK button 208) (step S40), the panel control unit 140 instructs the integrated control unit 120 to execute the storing of the image data (step S41). Furthermore, the panel control unit 140 passes, to the integrated control unit 120, the character string displayed in the file name candidate display part 205 at this time point, as the validated character string.

When the integrated control unit 120 receives the instruction of step S41, the integrated control unit 120 generates image data of an image obtained by rotating the image of each page in the image data obtained as the reading result, by the rotation angle reported in step S26, according to need (when the image has been rotated in step S26) (step S42). Alternatively, only the image in the page including the specified area may be rotated.

Then, the integrated control unit 120 passes, to the storage control unit 160, the generated image data or the image data obtained as the reading result (when the image is not rotated), together with the information of the character string passed in step S41, and instructs the storage control unit 160 to store the received image data by the file name based on the character string (step S43).

The storage control unit 160 sets the file name as management information in the image data according to the instruction, and stores the image data in a predetermined storage unit (step S44). At this time, the storage control unit 160 may perform a process such as attaching an extension to the character string passed in step S41, as described above. By the processes up to step S44, the series of operations relevant to storing the image data are ended.

The image processing apparatus performing the above operations is able to present an image that is the processing target to the user; receive a specification of an area in the image; perform a character recognition process on the specified area in the image that is the processing target; and set the management information of the image that is the processing target based on the character string acquired by the character recognition process. Therefore, it is possible to set the management information of the image based on a desired character string included in the image, while efficiently limiting the range of performing the character recognition process. Therefore, the setting of the management information can be realized with a low processing load and high operability.

Furthermore, when the image that is the processing target includes a plurality of pages, the page to be presented to the user can be switched, and therefore even when the character string to be used as the management information is included in the second page and onward, the user is able to specify the area including the character string without any problem.

Furthermore, it is possible to rotate the orientation of the image to be presented to the user, and therefore even when the image has been read in an oblique manner, the user can easily specify the area including the desired character string.

Furthermore, the character recognition process is performed on an image obtained by rotating the image obtained as the reading result according to the rotation angle of the image at the time point when the specification of the area is received. Therefore, even when the image in the image data obtained as the reading result is oblique, it is expected that the character recognition process is performed on an image in which the oblique state has been corrected as visually observed by the user. Accordingly, it is possible to perform the character recognition process on the image that is oriented such that the character string can be properly read, and therefore the reading precision is improved.

Furthermore, the image obtained as the reading result is replaced with an image that has been rotated as described above, and the rotated image is stored, and therefore when reference is later made to the image, it is expected that reference can be made to an image that has been corrected from an oblique state.

The present embodiment is described; however, the present invention is not limited to the above embodiment in terms of the specific configuration of the device, the specific processing procedures, the user interface to be used, etc.

For example, the trigger to start reading the original document may not be a start operation by the user, but may be another event such as the operation of placing the original document.

Furthermore, in the above embodiment, a description is given of an example where a specification of one area in the image is received from the user; however, specifications of a plurality of areas may be received. In this case, priority levels are to be applied to the specified areas, an OCR process is to be performed on each of the areas, the character strings in the areas obtained by the OCR processes are to be sequentially connected in a descending order according to the priority levels of the corresponding areas, and a character string obtained by connecting the character strings is to be set as the management information such as a file name.

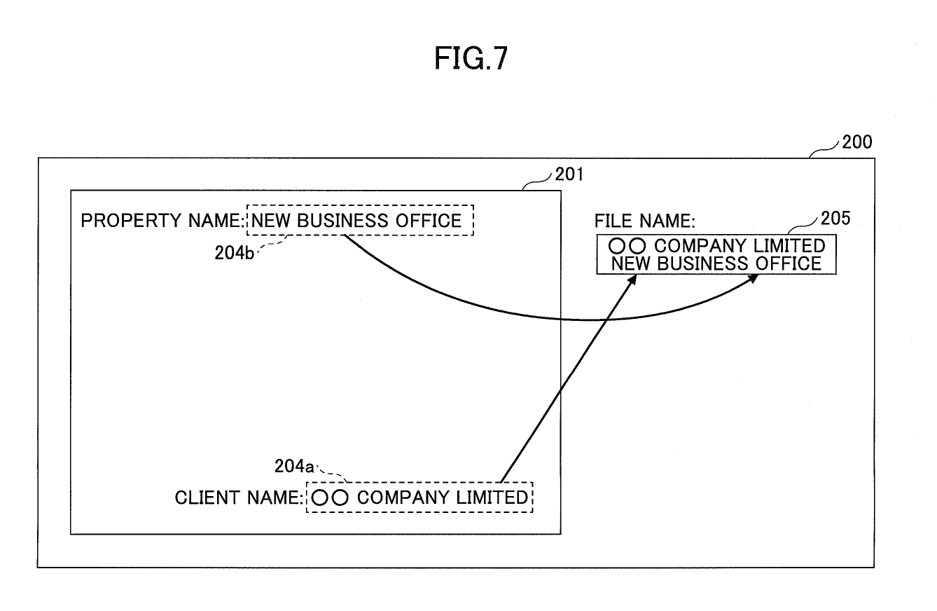

FIG. 7 illustrates an example of area specification of the above case.

When the user specifies an area 204a and an area 204b in the image display area 201 of the area specification receiving screen 200, the OCR processing unit 150 performs an OCR process on each of the images in the areas 204a, 204b. Here, assuming that the priority level of the area 204a is higher, “◯◯ Company Limited” obtained from the area 204a is arranged first, and “New Business Office” obtained from the area 204b is arranged next, thereby obtaining “◯◯ Company Limited New Business Office” as the candidate of a file name based on the result of OCR.

Note that a plurality of areas may be specified upon performing, for example, a flick operation on each of the plurality of areas, and then validating the specification by operating a specification validation button (not illustrated). Furthermore, the specification of the priority levels can be performed at the same time, assuming that the areas flicked first have higher priority levels.

Furthermore, at the time point when a flick operation is performed on the first area, this operation may be received as a specification of an area, and a character string, which is obtained by performing an OCR process on the specified area, may be displayed in the file name candidate display part 205 as in step S32 of FIG. 5. Subsequently, at the time point when a flick operation is performed on another area, a character string, which is obtained by performing an OCR process on the specified area, may be connected after the character string that is already displayed. By this method also, it is possible to sequentially connect the character strings obtained from a plurality of areas in a descending order according to the priority levels of the corresponding areas, and the character string obtained by connecting the character strings can be set as a candidate of the management information.

As described above, when it is possible to specify a plurality of areas, even when the character strings to be used for setting the management information are arranged at sporadic positions that are away from each other in the image, it is possible to easily set the management information based on a character string obtained by connecting the character strings arranged at sporadic positions.

Note that it is possible to specify an area in each of a plurality of different pages. Furthermore, the shape of the specified area is not limited to a rectangle. Furthermore, an area, which is surrounded by an arbitrary shape indicated by the user, may be specified, other than a shape defined in advance.

Furthermore, another possible method is to obtain a character string by performing an OCR process on an area specified first, display the obtained character string on the file name candidate display part 205, obtain a character string by performing an OCR process on an area specified next, and insert the next character string at an arbitrary position in the displayed character string.

For example, at the time point when the character string obtained from the area specified first is displayed in the file name candidate display part 205, the cursor is placed at the end of the character string, and then the user arbitrarily moves the cursor to specify the position where the next character string is to be inserted. Accordingly, an operation of editing a character string as the following (1) through (3) can be performed.

(1) First, an area including a specification number is specified, an OCR process is executed on the specified area, and a specification number such as “No. 1234” included in the area is displayed in the file name candidate display part 205.

(2) The cursor, which is positioned behind “4” at the time point of (1) described above, is moved before “N” by operating a cursor key, etc.

(3) An area including the characters “Specification” in the image is selected, an OCR process is executed on the selected area, and “Specification”, which is a character string in the area, is inserted in the position of the cursor. As a result, the character string in the file name candidate display part 205 becomes “Specification No. 1234”.

Subsequently, the character string may be directly edited to insert a space, such that a character string “Specification No. 1234” is created.

Furthermore, as another modification, an OCR process is not only performed on the specified area. An area may be generated by changing the position or the size of the specified area by a predetermined variation range, and an OCR process may be also performed on the generated area. Then, the character string in the specified area and the character string in the generated area are both presented to the user, such that the user can select a character string to be used for setting the management information, from the presented character strings.

There may be cases where the user is unable to accurately specify the area including the desired character string without excess or deficiency, when the display displaying the image is insufficient in size and resolution. Therefore, it is possible to allow a certain amount of displacement in the specification of an area, and the OCR process may be performed on areas that are slightly displaced in terms of the position and size. Accordingly, it is expected that the desired character string is obtained without excess or deficiency from one of the areas.

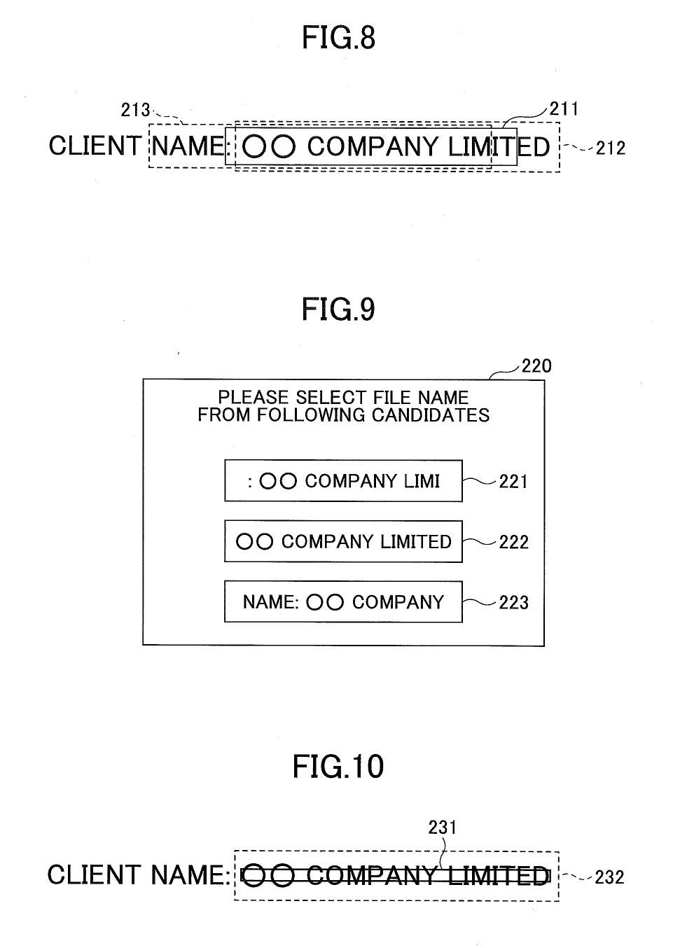

FIG. 8 illustrates an example where the position of the area is displaced.

An area 211 indicated by a solid line is the area specified by the user, and areas 212, 213 indicated by dashed lines are areas generated by moving the area 211 to the left and right by a predetermined variation range. In FIG. 8, the sizes of the areas are slightly different in the vertical direction as a matter of convenience in illustrating the diagram; however, the size need not be changed (or the size may not be prevented from being changed).

In the example of FIG. 8, when an OCR process is performed on each of the areas 211 through 213, the character strings of “: ◯◯ Company Limi”, “◯◯ Company Limited”, and “name: ◯◯ Company”, are obtained. The user may select which one of these character strings are to be used, from a character string selection screen 220 as illustrated in FIG. 9. The buttons 221 through 223 respectively correspond to the character strings obtained from the areas 211 through 213, respectively.

FIG. 10 illustrates an example in which the size of the area is changed.

An area 231 indicated by a solid line is the area specified by the user, and an area 232 indicated by a dashed line is an area generated by enlarging the area 231 by a predetermined variation range.

In the example of FIG. 10, even when an OCR process is performed on the area 231, there are no characters that are completely included in the area, and therefore a character string cannot be obtained. However, when an OCR process is performed on the area 232, the character string “◯◯ Company Limited” is obtained. An area from which a character string cannot be obtained like the area 231 does not need to be an option, and therefore the user may select a character string to be used for setting the management information only from an area from which a character string has been obtained. In the example of FIG. 10, there is only one option, and therefore the character string obtained from the area 232 can be used without making any selection.

Other than the examples indicated in FIGS. 8 and 10, the OCR process may be performed on an area that has been changed by an arbitrary method, such as moving the area in the vertical direction as viewed in the diagram, reducing the image, a combination of moving the area and changing the size of the area, etc. In the image reading device described herein, it is considered that the size of each specified area is not that large, and therefore it is considered that the processing load does not become excessively high even when the OCR process is performed on a plurality of areas.

Furthermore, the above embodiment describes an example in which a specification of an area in an image indicated by image data that has been obtained by reading an original document, is received, and management information is set. However, in another modification, the same process may be performed on an image obtained by reading image data that has been created and stored in advance. This process may be performed in an example where image data is temporarily automatically stored by a file name according to the created time and date, a serial number, etc., and the image data is subsequently renamed by a file name expressing the contents of the image data.

Furthermore, the processing target is not limited to image data that has been created by a reading operation. Image data that has been generated by rendering with some software may also be a processing target. Therefore, the image reading function is not essential to the image processing apparatus according to an embodiment of the present invention. Conversely, the image processing apparatus may be constituted by an MFP (digital multifunction peripheral) including an image forming function in addition to an image reading function.

Furthermore, the purpose of the image or image data in which management information is set, is not limited to storage. The image or image data may be sent, together with the management information, to a storage in an external network, an external database, etc., by an appropriate communication means such as an e-mail, without being stored in the image reading device 100 in a fixed manner.

Furthermore, in the above embodiment, the image is presented to the user by displaying the image on a screen; however, other methods may be used for presenting the image. For example, the image may be presented by projecting the image on a screen.

Furthermore, the functions of the image reading device 100 according to the above embodiment may be provided by being distributed across a plurality of information processing apparatuses, such as by providing some of the functions in an external device. In this case, an image processing system is constituted, in which a plurality of devices has the same image processing functions as those of the image reading device 100. A single information processing apparatus may constitute an image processing system.

Furthermore, the image processing apparatus according to an embodiment of the present invention does not need to include all of the functions described in the above embodiment. For example, the functions of the image reading unit 130, the page switching unit 143, the image rotation unit 144, the character string editing unit 145, the character string display unit 146, and the image storage unit 162 in FIG. 2 are not essential.

According to one embodiment of the present invention, an image processing apparatus, an image processing system, and an image processing method are provided, which are capable of realizing a process of setting the management information of an image, based on a desired character string included in the image, with a low processing load and high operability.

The image processing apparatus, the image processing system, and the image processing method are not limited to the specific embodiments described herein, and variations and modifications may be made without departing from the spirit and scope of the present invention.

The present application is based on and claims the benefit of priority of Japanese Priority

Patent Application No. 2014-087130, filed on Apr. 21, 2014, and Japanese Priority Patent Application No. 2015-078125, filed on Apr. 7, 2015, the entire contents of which are hereby incorporated herein by reference.

What is claimed is:

1. An image processing apparatus comprising:
a receiving unit configured to present an image that is a processing target to a user and receive a specification of an area in the image;
a character recognition unit configured to perform a character recognition process on the area for which the receiving unit has received the specification in the image that is the processing target, and acquire an information item of a character string in the area; and
a setting unit configured to set management information of the image that is the processing target, based on the character string acquired by the character recognition unit.

2. The image processing apparatus according to claim 1, wherein
the receiving unit receives specifications of a plurality of areas in the image that is the processing target, together with specifications of priority levels of the plurality of areas,
the character recognition unit performs the character recognition process on each of the plurality of areas for which the receiving unit has received the specifications, and acquires information items of character strings in the respective plurality of areas, and
the setting unit sets the management information based on a character string, which is obtained by sequentially connecting the character strings in the respective plurality of areas, which have been acquired by the character recognition unit, in a descending order according to the priority levels of the corresponding areas.

3. The image processing apparatus according to claim 1, wherein
the image that is the processing target includes a plurality of pages, and
the receiving unit includes a switching unit configured to switch a page to be presented to the user among the plurality of pages.

4. The image processing apparatus according to claim 1, wherein
the receiving unit includes a rotation unit configured to rotate an orientation of the image to be presented to the user.

5. The image processing apparatus according to claim 4, wherein
the character recognition unit performs the character recognition process on the image that is the processing target, which has been rotated according to a rotation angle by the rotation unit at a time point when the receiving unit receives the specification of the area.

6. The image processing apparatus according to claim 4, further comprising:
a replacing unit configured to generate an image by rotating the image that is the processing target according to a rotation angle by the rotation unit at a time point when the receiving unit receives the specification of the area, and replace the image that is the processing target with the rotated image.

7. The image processing apparatus according to claim 1, wherein
the character recognition unit generates an area that has been changed in terms of a position or a size by a predetermined variation range, based on the area for which the receiving unit has received the specification, performs the character recognition process on the specified area and the generated area, and acquires information items of character strings in the specified area and the generated area, and
the setting unit presents, to the user, the character strings in the specified area and the generated area acquired by the character recognition unit, and sets the management information of the image that is the processing target based the character string selected by the user from the presented character strings.

8. The image processing apparatus according to claim 1, wherein
the image that is the processing target is obtained by reading an original document.

9. An image processing system comprising:
a receiving unit configured to present an image that is a processing target to a user and receive a specification of an area in the image;
a character recognition unit configured to perform a character recognition process on the area for which the receiving unit has received the specification in the image that is the processing target, and acquire an information item of a character string in the area; and
a setting unit configured to set management information of the image that is the processing target, based on the character string acquired by the character recognition unit.

10. An image processing method comprising:
presenting an image that is a processing target to a user and receiving a specification of an area in the image;
performing a character recognition process on the area for which the specification has been received in the image that is the processing target, and acquiring an information item of a character string in the area; and
setting management information of the image that is the processing target, based on the acquired character string.
